(19) United States
(12) Patent Application Publication
(10) Pub. No.: US 2025/0208916 A1
(43) Pub. Date: Jun. 26, 2025

(54) EFFICIENCY DAEMON

(71) Applicant: Google LLC, Mountain View, CA (US)

(72) Inventors: Alexander Ray Curtis, Seattle, WA (US); Pawel Tadeusz Kepka, Warsaw (PL); Vyacheslav Vladimirovich Malyugin, Waterloo (CA); Adin Matthew Scannell, San Diego, CA (US); David G. Porter, Kirkland, WA (US); Pawel Jacob Mendelski, Poznan (PL); Jayant Jain, Warsaw (PL); Marian Kedzierski, Mountain View, CA (US); William Mcguffin Wright Denniss, Redwood City, CA (US); Jeremy Olmsted-Thompson, Mountain View, CA (US)

(73) Assignee: Google LLC, Mountain View, CA (US)

(21) Appl. No.: 18/986,057

(22) Filed: Dec. 18, 2024

Related U.S. Application Data
(60) Provisional application No. 63/612,401, filed on Dec. 20, 2023.

(51) Int. Cl. G06F 9/50

(52) U.S. Cl. CPC G06F 9/5027; G06F 9/5016

(57) ABSTRACT

A method includes receiving a request to provision a plurality of containers including a resource requirement representing an amount of resources the respective container requires. The method also includes provisioning a machine that includes a first amount of resources. The method includes determining a second amount of resources based on a sum of each resource requirement of each respective container. The second amount of resources is less than the first amount of resources. The second amount of resources is greater than the resource requirement of each respective container. The method includes restricting each respective container of the plurality of containers to the second amount of resources that prohibits each respective container from utilizing more resources than the second amount of resources. After restricting each respective container of the plurality of contains to the second amount of resources, the method includes executing the plurality of containers on the machine.

### CROSS REFERENCE TO RELATED APPLICATIONS

This U.S. patent application claims priority under 35 U.S.C. § 119(e) to U.S. Provisional Application 63/612,401, filed on Dec. 20, 2023. The disclosure of this prior application is considered part of the disclosure of this application and is hereby incorporated by reference in its entirety.

### TECHNICAL FIELD

This disclosure relates to efficiency daemons for containerized orchestration systems.

### BACKGROUND

Some cloud-based services (via distributed systems) offer containerized orchestration systems. These systems have reshaped the way software is developed, deployed, and maintained by providing virtual machine-like isolation capabilities with low overhead and high scalability. Software applications execute in secure execution environments (e.g., containers or pods) and co-located pods may be grouped into clusters, each cluster isolated from other clusters. Ensuring that these applications are provided with sufficient computational resources (e.g., processing and memory resources) without over-providing these resources in such an environment is a challenging task, especially when advanced features such as opportunistic bursting are considered.

### SUMMARY

One aspect of the disclosure provides a method for an efficiency daemon. The computer-implemented method is executed by data processing hardware that causes the data processing hardware to perform operations. The operations include receiving a request to provision a plurality of containers. Each respective container of the plurality of containers is to execute a respective software application. The request includes, for each respective container of the plurality of containers, a resource requirement representing an amount of resources the respective container requires. The operations include provisioning a machine for the plurality of containers. The machine includes a first amount of resources. The method includes determining a second amount of resources based on a sum of each resource requirement of each respective container of the plurality of containers. The second amount of resources less than the first amount of resources. The second amount of resources greater than the resource requirement of each respective container of the plurality of containers. The method includes restricting each respective container of the plurality of containers to the second amount of resources. The restriction prohibits each respective container of the plurality of containers from utilizing more resources than the second amount of resources. After restricting each respective container of the plurality of contains to the second amount of resources, the operations include executing the plurality of containers on the machine.

Implementations of the disclosure may include one or more of the following optional features. In some implementations, the resources include central processing unit (CPU) resources. In some of these implementations, restricting each respective container of the plurality of containers to the second amount of resources includes offlining one or more CPUs. In some of these implementations, restricting each respective container of the plurality of containers to the second amount of resources includes using a process scheduler.

Optionally, the resources include memory resources. In some examples, restricting each respective container of the plurality of containers to the second amount of resources includes determining a difference between the first amount of resources and the second amount of resources.

In some examples, the operations further include, after executing the plurality of containers on the machine, receiving a second request adjusting a quantity of containers in the plurality of containers, determining a third amount of resources based on a sum of each resource requirement of each respective container of the adjusted plurality of containers, and restricting each respective container of the adjusted plurality of containers to the third amount of resources. In some of these examples, the second request terminates one or more containers of the plurality of containers. Optionally, the second request adds one or more containers to the plurality of containers.

In some implementations, executing the plurality of containers on the machine includes enabling each respective container of the plurality of containers to consume a third amount of resources that is greater than the resource requirement of the respective container and less than the second amount of resources.

Another aspect of the disclosure provides a system for an efficiency daemon. The system includes data processing hardware and memory hardware in communication with the data processing hardware. The memory hardware stores instructions that when executed on the data processing hardware cause the data processing hardware to perform operations. The operations include receiving a request to provision a plurality of containers. Each respective container of the plurality of containers is to execute a respective software application. The request includes, for each respective container of the plurality of containers, a resource requirement representing an amount of resources the respective container requires. The operations include provisioning a machine for the plurality of containers. The machine includes a first amount of resources. The method includes determining a second amount of resources based on a sum of each resource requirement of each respective container of the plurality of containers. The second amount of resources less than the first amount of resources. The second amount of resources greater than the resource requirement of each respective container of the plurality of containers. The method includes restricting each respective container of the plurality of containers to the second amount of resources. The restriction prohibits each respective container of the plurality of containers from utilizing more resources than the second amount of resources. After restricting each respective container of the plurality of contains to the second amount of resources, the operations include executing the plurality of containers on the machine.

This aspect may include one or more of the following optional features. In some implementations, the resources include central processing unit (CPU) resources. In some of these implementations, restricting each respective container of the plurality of containers to the second amount of resources includes offlining one or more CPUs. In some of these implementations, restricting each respective container of the plurality of containers to the second amount of resources includes using a process scheduler.

Optionally, the resources include memory resources. In some examples, restricting each respective container of the plurality of containers to the second amount of resources includes determining a difference between the first amount of resources and the second amount of resources.

In some examples, the operations further include, after executing the plurality of containers on the machine, receiving a second request adjusting a quantity of containers in the plurality of containers, determining a third amount of resources based on a sum of each resource requirement of each respective container of the adjusted plurality of containers, and restricting each respective container of the adjusted plurality of containers to the third amount of resources. In some of these examples, the second request terminates one or more containers of the plurality of containers. Optionally, the second request adds one or more containers to the plurality of containers.

In some implementations, executing the plurality of containers on the machine includes enabling each respective container of the plurality of containers to consume a third amount of resources that is greater than the resource requirement of the respective container and less than the second amount of resources.

The details of one or more implementations of the disclosure are set forth in the accompanying drawings and the description below. Other aspects, features, and advantages will be apparent from the description and drawings, and from the claims

### DESCRIPTION OF DRAWINGS

FIG. 1 is a schematic view of an example system for a containerized orchestration system.

FIGS. 2A and 2B are schematic views for restricting resources of the containerized orchestration system of FIG. 1 to applications.

FIG. 3 is a flowchart of an example arrangement of operations for a method of restricting resources in a containerized orchestration system.

FIG. 4 is a schematic view of an example computing device that may be used to implement the systems and methods described herein.

Like reference symbols in the various drawings indicate like elements.

### DETAILED DESCRIPTION

Containerized applications, and the systems that orchestrate containerized applications, are becoming increasingly popular due to, at least in part, advances in remote and distributed computing. These advances have enabled the development of sophisticated container orchestration platforms that provide robust frameworks for managing containerized workloads. These platforms offer features such as automated deployment, scaling, and operations of application containers across clusters of hosts, providing a highly efficient and scalable environment for running applications. Containerized applications (i.e., virtualization) allow for the existence of isolated user or application space instances. Each instance (i.e., container) may appear to the application as its own personal computer with access to all the resources necessary to execute (e.g., storage, network access, etc.). This isolation ensures that applications running in different containers do not interfere with each other, providing a secure and stable environment for application execution Containers are lightweight and share the host system's kernel, which makes them more efficient than traditional virtual machines that require separate operating system instances.

A container typically will be limited to a single application or process or service. Some container-orchestration systems deploy pods as the smallest available computing unit. A pod is a group of one or more containers, each container within the pod sharing isolation boundaries (e.g., IP address). Controllers control resources in pods. Controllers are responsible for monitoring the health of pods, containers, and resources (and recreating the pods/containers if necessary). Controllers are also responsible for replicating and scaling pods, as well as monitoring for external (to the pod) events. For example, in some systems, a replica controller ensures that a specified number of pod replicas are running at any given time, while a deployment controller provides declarative updates to applications, allowing for seamless rollouts and rollbacks.

A single physical machine (i.e., computer or server) hosts one or more containers (e.g., pods). The container-orchestration system will often coordinate multiple containerized applications across many pods using a cluster of physical machines. Typically, each machine in the cluster is co-located (i.e., the machines are geographically located near each other) with one or more machines functioning as a master server and the remaining machines functioning as nodes. The master server acts as the primary control plane and gateway for the cluster by, for example, exposing an Application Programming Interface (API) for clients, health checking the nodes, orchestrating communication, scheduling, etc. The nodes are responsible for accepting and executing workloads using local and external resources and each node creates and destroys containers as instructed by the master server. Clients interact with the cluster by communicating with the master server (e g., directly or via libraries). The master server typically includes components such as the API server, etcd (a key-value store for cluster data), the scheduler, and various controllers.

The nodes within the cluster are generally isolated and segregated from contact outside of the cluster except as allowed by the master server. This isolation ensures that the workloads running on the nodes are secure and that the cluster's internal network is protected from external threats. Network policies can be defined to control the traffic flow between pods and services within the cluster, further enhancing security.

In some scenarios, a single physical or virtual machine hosts multiple pods. In some examples, each pod on the machine is owned by the same owner. For example, an owner may request that the orchestration system create/provision multiple pods for the owner. The owner may request that each pod be co-located on the same physical or virtual machine. Alternatively, the orchestration system may automatically determine that each pod is to be co-located on the same machine. Typically, each pod or container is associated with a respective resource requirement. The resource requirement dictates the amount of resources that should be reserved or assigned to the pod. In some examples, the resource requirement is requested by the owner of the pod and is associated with an amount of service that the owner has purchased. That is, in some examples, an owner of a respective pod requests and pays for a given amount of resources (e.g., processing resources, memory resources, storage resources, etc.) to be available to the respective pod. Typically, each pod is limited to accessing the amount of resources defined by the resource requirement. This ensures that the resources are allocated efficiently and that no single pod can monopolize the resources of the machine.

A valuable feature for an orchestration system is the ability to allow a respective pod (i.e., the application executing within the pod) to “burst” past the resource requirement and temporarily consume additional idle resources of the machine the respective pod is hosted by. For example, when an owner owns three pods hosted on the same machine, it is advantageous to allow, when two of the pods are idle, the third pod to temporarily use resources (i.e., burst) assigned to the two idle pods. This opportunistic bursting allows for better utilization of resources and can improve the performance of applications during peak demand periods.

Implementations herein are directed toward a containerized orchestration system that allows applications to temporarily access or consume resources beyond what the application requested to use without allowing the owner of the application to utilize resources that are not assigned to the owner and without starving other applications executing on the same machine. The system may allow applications to consume resources up to an amount that is based on or equal to a sum of all resources assigned to the pods executing on the machine.

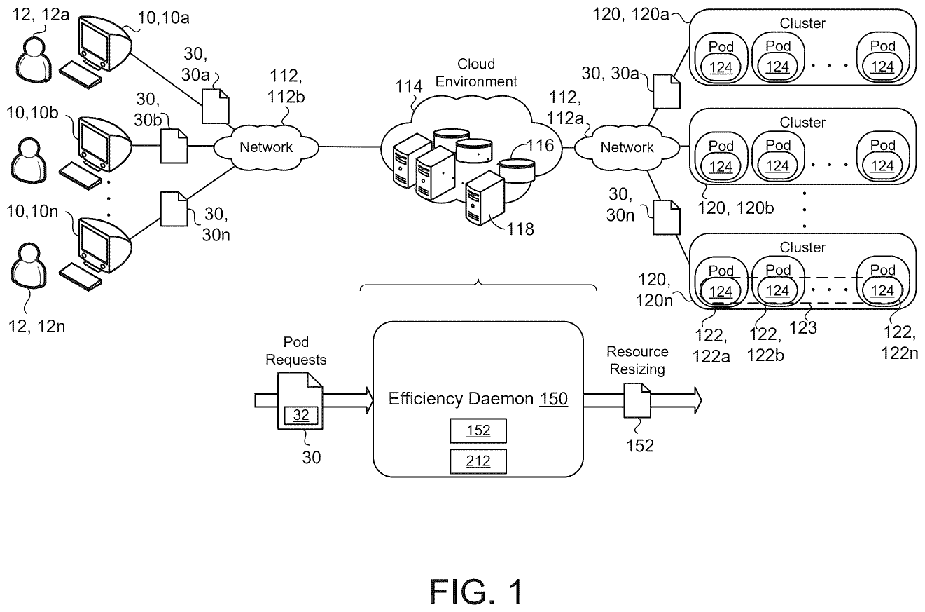

Referring now to FIG. 1, in some implementations, an example system 100

includes a remote system 114. The remote system 114 may be a single computer, multiple computers, or a distributed system (e.g., a cloud environment) having scalable/elastic computing resources 118 (e.g., data processing hardware) and/or storage resources 116 (e.g., memory hardware). The remote system 114 includes or communicates with, via network 112a, one or more clusters 120, 120a-n, and each cluster 120 includes one or more pods 122, 122a-n (also referred to herein as containers 122), each executing one or more applications 124. While the examples herein describe the clusters 120 including one or more pods 122, the clusters 120 may include any type of containers for executing the one or more software applications 124 without departing from the scope of the present disclosure. In some examples, part or all of one or more of the clusters 120 executes on the remote system 114. Some pods 122 may execute the same applications 124, while some pods 122, within the same cluster 120 or a different cluster 120, may execute different applications 124. For example, each cluster 120 may include pods 122 that execute a shopping application 124. A service 123 represents one or more applications 124 executing on multiple pods 122 within the same cluster 120. To continue the previous example, a shopping service 123 may use the shopping application 124 that is executing on multiple pods 122. For example, all pods 122 executing the shopping application 124 may be associated with the shopping service 123, and each respective pod 122 may be a fungible resource to fulfill a request 30 to use the shopping service 123.

Different clusters 120 may be associated with different geographical areas. For example, the cluster 120a may be associated with the geographical region of Asia, the cluster 120b may be associated with the geographical region of Europe, and the cluster 120n may be associated with the geographical region of North America. In some examples, each cluster 120 may be associated with the geographical region of where the cluster 120 is physically located.

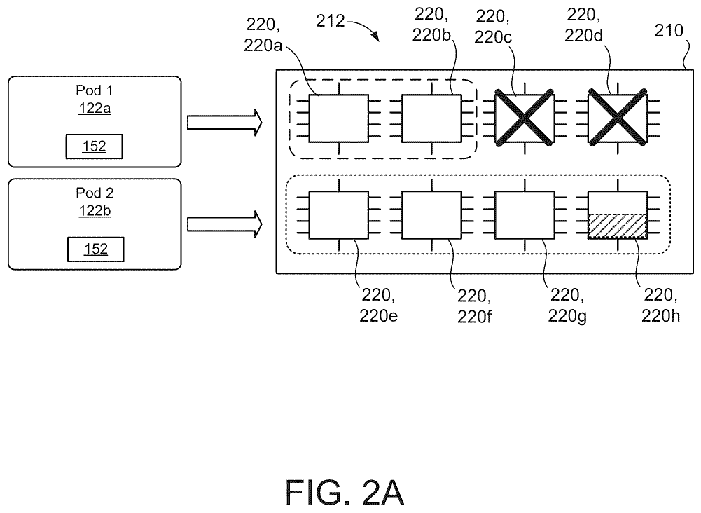

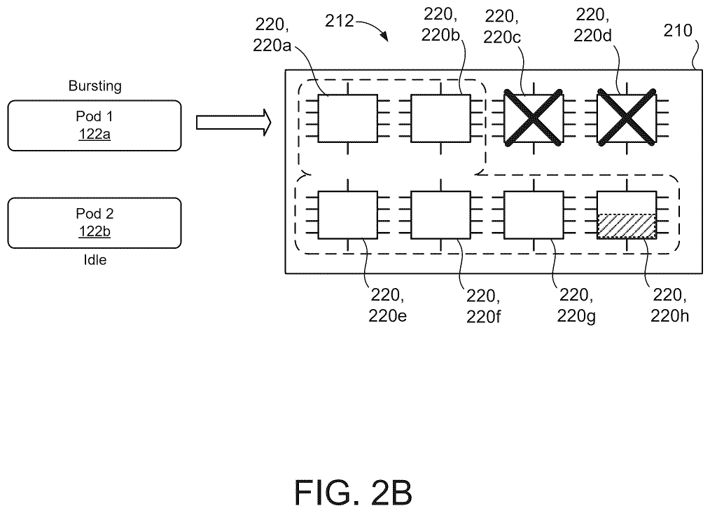

Each pod 122 is hosted on a machine 210 (FIG. 2A). Each machine 210 may host one or more pods 122. Each machine 210 may represent a single physical machine or computer or server. Alternatively, each machine 210 represents a single virtual machine which may be hosted on any number of physical machines.

The remote system 114 is also in communication with one or more clients 10, 10a-n via a network 112b. The networks 112a, 112b may be the same network or different networks. Each client 10 may correspond to any suitable computing device, such as a desktop workstation, laptop workstation, mobile device (e.g., smartphone or tablet), wearable device, smart appliance, smart display, or smart speaker. The clients transmit pod requests 30, 30a-n to the remote system 114 via the network 112b. The pod 122 requests 30 request that the remote system 114 create and/or delete pods 122 on behalf of the respective user 12 (i.e., the owner 12 of the pods 122).

The remote system 114 executes an efficiency daemon 150. The efficiency daemon receives a pod request 30 to provision pods 122 (also referred to herein as containers 122) for a respective user 12 or owner. Each respective container 122 to be provisioned is to execute a respective software application 124. The request 30 includes, for each respective container 122 to be provisioned, a resource requirement 32 representing an amount of resources the respective container 122 requires. The resource requirement 32 may be based on the resources necessary to execute the application 124. In some examples, the resource requirement 32 is based on an amount of services the owner pays for or subscribes to The efficiency daemon 150 ensures that the resources are allocated according to the resource requirements specified in the request.

Referring now to FIG. 2A, the remote system 114 provisions a machine 210 (i.e., a single physical machine 210 or a virtual machine 210 that includes at least a portion of multiple physical machines) for the containers 122 of the request 30. The machine 210 includes an available amount of resources 212. The available amount of resources 212 may include computing resources (i.e., central processing unit (CPU) resources), memory resources, and/or storage resources. In the example of FIG. 2A, the machine 210 includes eight CPUs 220, 220a-h. In this example, the eight CPUs 220 may make up the available amount of resources 212 (i.e., computing resources). The available amount of resources 212 may represent an amount of resources that the machine 210 is equipped with or can provide to pods 122. The efficiency daemon 150 ensures that the machine 210 has sufficient resources to meet the requirements of the pods 122 to be provisioned.

Referring back to FIG. 1, the efficiency daemon 150 determines a required amount of resources 152 based on a sum of each resource requirement 32 of each respective container 122 requested by the pod request 30. In some examples, the required amount of resources 152 is equal to the sum of each resource requirement 32. In other examples, the required amount of resources 152 is equal to the sum of each resource requirement 32 adjusted by other parameters (e.g., an amount of system resources required by the remote system 114 to control or coordinate the machine 210 and/or pods 122). The required amount of resources 152 is less than the available amount of resources 212 and the required amount of resources 152 is greater than the resource requirement 32 of each respective container 122. This ensures that the machine 210 has enough resources to meet the needs of the pods 122 while also reserving some resources for system operations.

As discussed in more detail below, the efficiency daemon 150 restricts each respective container 122 to the required amount of resources 152. The restriction prohibits each respective container 122 from utilizing more resources than the required amount of resources 152. After restricting each respective container 122 to the required amount of resources 152, the remote system 114 executes the requested containers 122 on the machine 210. This restriction ensures that no single container can monopolize the resources of the machine 210, allowing for fair resource allocation among all containers.

Referring again to FIG. 2A, an exemplary first pod 122a (i.e., “Pod 1”) has a resource requirement 32 of two CPUs 220. An exemplary second pod 122b (i.e., “Pod 2”) has a resource requirement 32 of three and a half (3.5) CPUs 220. The remote system 114 may receive the required amount of resources 152 from the owner 12 (e.g., via the request 30). Alternatively, the remote system 114 automatically determines the required amount of resources 152 based on the application 124 the pod 122 is to execute or based on other parameters associated with the pod 122. The remote system 114 may select a particular machine 210 to host the pods 122 based on the required amount of resources 152 to ensure the machine 210 has sufficient resources to meet the required amount of resources 152. Additionally or alternatively, the remote system 114 selects the machine 210 based on other factors, such as the applications 124s to execute within the pods 122, owner preference determined via the request 30 or via a profile or the like, machines 210 available to the remote system 114, or any other factor. The remote system 114 may ensure that all pods 122 hosted on a particular machine 210 are owned by the same owner. This selection process ensures that the pods 122 are provisioned on the most suitable machine, taking into account various factors to optimize resource utilization.

In some scenarios, the machine 210 has more resources than required to meet the required amount of resources 152 of the pods 122. In the example of FIG. 2A, the first pod 122a requires two CPUs 220, the second pod 122b requires 3.5 CPUs 220, and the machine 210 is equipped with eight CPUs 220, 220a-h. Thus, in this example, the required amount of resources 152 is equal to 5.5 CPUs 220 (i.e., the sum of the resource requirements 32 of the first pod 122a and the second pod 122b) and the machine 210 is overprovisioned or has more resources than required. By default, the pods 122 may be allowed to use any idle resources (e.g., CPUs 220) provided by the machine 210, but in this example, such a feature would allow the pods 122a, 122b to use more resources than assigned to (or paid for by) the owner 12 of the pods 122a-b. This could incur additional cost for the remote system 114 and/or improperly incentivize the owner 12 (e.g., by causing the owner 12 to attempt to have a large machine 210 to host the pods 122a-b). To remedy this, the efficiency daemon 150 may inflate a resource “balloon” that limits the available resources to the pods 122. This resource balloon acts as a buffer to prevent overuse of resources and ensures that the pods 122 only use the resources they are allocated.

In some examples, when the resources requirement 32 is at least partially based on an amount of CPUs 220, the remote system 114 may use CPU offlining to reduce an amount of CPUs 220 available on the machine 210. CPU offlining generally includes turning off or otherwise disabling the use of one or more CPUs 220 of a machine 210. In the example of FIG. 2A, the first pod 122a requires two CPUs 220 and the second pod 122b requires 3.5 CPUs 220 for a total of 5.5 CPUs 220. However, the machine 210 includes eight CPUs 220a-h. In this example, the remote system 114 may use CPU offlining to offline two of the CPUs 220. More specifically, the remote system 114 offlines CPUs 220c, 220d, which causes these CPUs 220c, 220d to be unavailable to the pods 122a-b. This offlining process ensures that the pods 122 do not have access to more CPUs than they are allocated, preventing resource overuse.

In some examples, the remote system 114 may always offline CPUs 220 in pairs or some other quantities based on the architecture of the machine 210. Generally, CPU offlining is only capable of turning off an entire CPU 220 (i.e., cannot offline only a portion of a CPU 220). Thus, in the example of FIG. 2A, the pods 122a-b require 5.5 CPUs 220, but offlining 2 CPUs 220 results in six CPUs 220 being available to the pods 122a-b. Offlining additional CPUs 220 (e.g., three CPUs 220) is not possible, as then the total amount of CPUs 220 available would fall below the required amount of resources 152 of the pods 122a-b (i.e., two CPUs 220 plus 3.5 CPUs 220 for a total of 5.5 CPUs) This ensures that the offlining process does not reduce the available resources below the required amount, maintaining the necessary resource allocation for the pods 122.

In some examples, the remote system 114 uses CPU offlining to reduce the quantity of CPUs 220 to an amount as close to the required amount of resources 152 as possible (without going below) and allows the pods 122 to make use of the additional (i.e., unrequested) CPU 220. In the example of FIG. 2A, this would allow the pods 122 the use of six CPUs 220. In other examples, the remote system 114 additionally or alternatively uses a process scheduler to limit pods 122 to a fraction of a CPU 220. For example, the remote system 114 may use a Completely Fair Scheduler (CFS) to schedule processes of the pods 122 to ensure that the pods 122 do not exceed use of a particular fraction of a CPU 220. In the example of FIG. 2A, the remote system 114 may use the process scheduler to limit the use of one of the CPUs 220 to reduce the amount available to the pods 122 from six CPUs 220 (i.e., the eight CPUs 220 available to the machine 210 minus the two offlined CPUs 220c, 220d) to 5.5 CPUs 220. In this particular example, the remote system 114 uses the process scheduler to limit the availability of CPU 220h. This combination of CPU offlining and process scheduling ensures precise control over the available resources, preventing overuse while maintaining the necessary resource allocation.

The remote system 114 may use any combination of CPU offlining and process scheduling to reduce the amount of CPUs 220 available to the pods 122. A combination of the two may be most effective, as CPU offlining alone allows for less granular control (i.e., does not allow for fractional cores or CPUs 220) while process scheduling alone may lead to priority inversion (i.e., a pod 122 may “starve” another pod 122 from accessing resources). Thus, in some implementations, the remote system 114 uses CPU offlining to offline the maximum number of CPUs 220 possible based on the required amount of resources 152 and the available amount of resources 212 (e.g., the difference between the available amount of resources 212 and the required amount of resources 152 and rounded up to the nearest whole CPU 220). Then, process scheduling may be used to make up for any additional fractional CPU 220 provided to the pods 122. This approach ensures that the resource allocation is both precise and fair, preventing any single pod 122 from monopolizing the resources. In some implementations, the remote system 114 uses other techniques, such as CPU limits or idle injections to control the amount of CPUs 220 available to the pods 122.

The remote system 114 may establish the resource balloon (i.e., the reserved or offline or otherwise resources unavailable to the pods 122 on the machine 210) based on the initial request 30 to provision or create the pods 122. In some examples, the owner 12 may adjust or update the amount of pods 122 executing on the machine 210. For example, the user 12 or owner 12 sends a second request 30 that terminates one or more pods 122 or adds one or more pods 122 to the machine 210. Accordingly, the remote system 114 may periodically update or adjust the required amount of resources 152 based on the current number of pods 122 executing on the machine 210. In response to the adjusted required amount of resources 152, the remote system 114 may increase or decrease the resources available to the pods 122 (e.g., by offlining or onlining CPUs 220). In some examples, the remote system 114 adjusts the required amount of resources 152 on a schedule (e.g., once per minute, once per hour, once per day, etc.). In other examples, the remote system 114 adjusts the required amount of resources 152 based on or in response to a request 30. That is, receiving a request 30 from the user 12 to adjust the quantity of pods 122 may trigger the remote system 114 to adjust the required amount of resources 152. In some examples, the remote system 114 ensures the required amount of resources 152 is adjusted prior to any applications 124 executing in newly added or created pods 122. For example, the remote system 114 prohibits execution of applications 124 in new pods 122 until the resource balloon has been properly inflated or deflated (i.e., by decreasing or increasing the resources available to the pods 122).

Referring now to FIG. 2B, in some implementations, the remote system 114 enables a respective pods 122 to use resources that exceed the resource requirement 32 of the respective pod 122 (i.e., burst) but does not exceed the required amount of resources 152 (e.g., the sum of the resource requirements 32 of each pod 122 executing on the machine 210). In the example of FIG. 2B, the required amount of resources 152 is 5.5 CPUs 220 (i.e., two CPUs 220 for the first pod 122a and 3.5 CPUs 220 for the second pod 122b). Here, the second pod 122b is idle (i.e., not using the CPUs 220) and the first pod 122a is able to burst or use up to 5.5 CPUs 220 (which is 3.5 CPUs more than the requested or reserved two CPUs 220 for the first pod 122a).

While examples herein have referred to the resources as being CPUs 220, the remote system and efficiency daemon 150 may adjust or restrict any other type of resource used by the pods 122, such as memory, storage, bandwidth, etc. In some implementations, the remote system 114 adjusts an amount of memory available to the pods 122 based on the resource requirements 32 of each pod 122. The pods 122 may similarly “burst” and use memory assigned to other pods 122 when the other pods 122 are not using the memory. The remote system 114 may increase the amount of memory available to the pods 122 when a request 30 increases the resource requirements 32 of the pods 122. Similarly, the remote system 114 may decrease the amount of memory available to the pods 122 when a request 30 decreases the amount of memory available to the pods 122. When decreasing the amount of memory, the remote system 114 may be required to terminate one or more applications 124 that are using an amount of memory that exceeds the updated amount of memory provided. In these examples, the remote system 114 may attempt to restart the application 124 after adjusting the memory and/or alert the owner 12 of the termination.

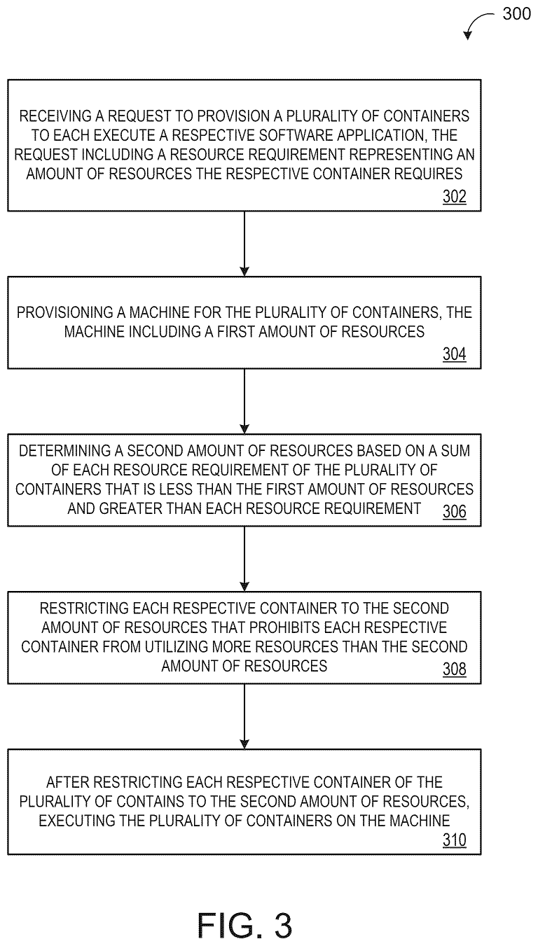

FIG. 3 is a flowchart of an exemplary arrangement of operations for a method 300 of using an efficiency daemon 150 to limit resources provided to pods 122 executing on a machine 210. The method 300 ensures efficient resource allocation, reducing the likelihood of resource wastage and improving overall system performance. The computer-implemented method 300 is executed by data processing hardware 118 that causes the data processing hardware 118 to perform operations. The method 300, at operations 302, includes receiving a request 30 to provision a plurality of containers 122. Each respective container 122 of the plurality of containers 122 to execute a respective software application 124. This operation allows for precise resource allocation tailored to the specific needs of each application, enhancing the efficiency and performance of the system. The request 30 may include, for each respective container 122 of the plurality of containers 122, a resource requirement 32 representing an amount of resources the respective container 122 requires (e.g., to execute the application 124).

The method 300, at operation 304, includes provisioning a machine 210 (e.g., a physical machine or a virtual machine) for the plurality of containers 122. This ensures that the system can handle the required workload efficiently. The machine 210 includes a first amount of resources 212, which optimizes resource utilization and minimizes idle resources.

The method 300, at operation 306, includes determining a second amount of resources 152 based on a sum of each resource requirement 32 of each respective container 122 of the plurality of containers 122. This step ensures that resources are allocated based on actual needs, preventing over-provisioning and underutilization. The second amount of resources 152 is less than the first amount of resources 212, which helps in maintaining an efficient balance between resource allocation and availability. The second amount of resources 152 is greater than the resource requirement 32 of each respective container 122 of the plurality of containers 122, ensuring that each container 122 has sufficient resources to operate effectively. At operation 308, the method 300 includes restricting each respective container 122 of the plurality of containers 122 to the second amount of resources 152. This restriction optimizes resource usage and prevents any single container 122 from monopolizing resources, thereby enhancing the overall system stability and performance That is, the restriction prohibits each respective container 122 of the plurality of containers 122 from utilizing more resources than the second amount of resources 152. At operation 310, the method 300 includes, after restricting each respective container 122 of the plurality of contains 122 to the second amount of resources 152, executing the plurality of containers 122 on the machine 210.

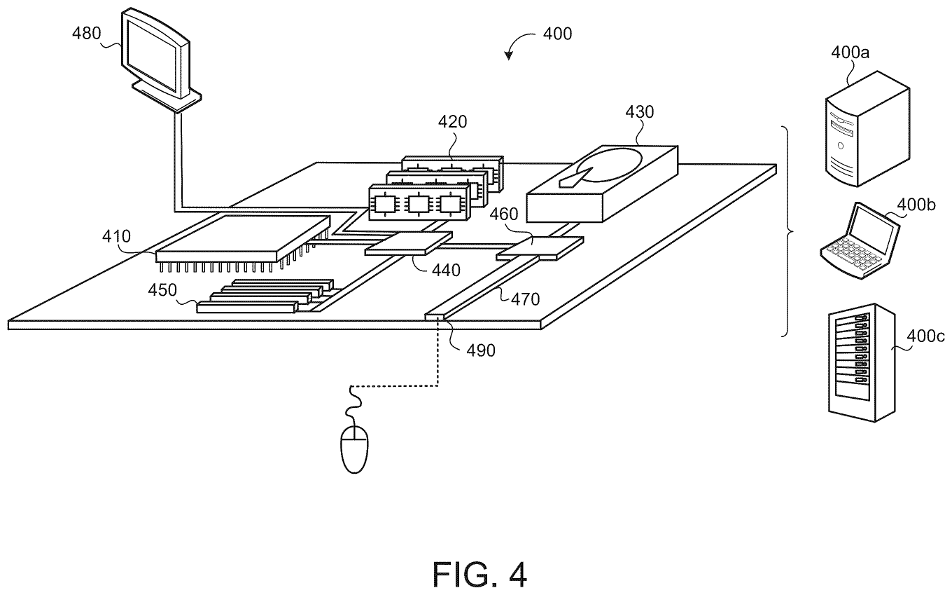

FIG. 4 is a schematic view of an example computing device 400 that may be used to implement the systems and methods described in this document. The computing device 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 400 includes a processor 410, memory 420, a storage device 430, a high-speed interface/controller 440 connecting to the memory 420 and high-speed expansion ports 450, and a low speed interface/controller 460 connecting to a low speed bus 470 and a storage device 430. Each of the components 410, 420, 430, 440, 450, and 460, are interconnected using various busses, and may be mounted on a common motherboard or in other manners as appropriate. The processor 410 can process instructions for execution within the computing device 400, including instructions stored in the memory 420 or on the storage device 430 to display graphical information for a graphical user interface (GUI) on an external input/output device, such as display 480 coupled to high speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system)

The memory 420 stores information non-transitorily within the computing device 400. The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 420, the storage device 430, or memory on processor 410.

The high speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed by data processing hardware that causes the data processing hardware to perform operations comprising:
receiving a request to provision a plurality of containers, each respective container of the plurality of containers to execute a respective software application, the request comprising, for each respective container of the plurality of containers, a resource requirement representing an amount of resources the respective container requires;
provisioning a machine for the plurality of containers, the machine comprising a first amount of resources;
determining a second amount of resources based on a sum of each resource requirement of each respective container of the plurality of containers, the second amount of resources less than the first amount of resources and greater than the resource requirement of each respective container of the plurality of containers;
restricting each respective container of the plurality of containers to the second amount of resources, the restriction prohibiting each respective container of the plurality of containers from utilizing more resources than the second amount of resources; and
after restricting each respective container of the plurality of contains to the second amount of resources, executing the plurality of containers on the machine.

2. The method of claim 1, wherein the resources comprise central processing unit (CPU) resources.

3. The method of claim 2, wherein restricting each respective container of the plurality of containers to the second amount of resources comprises offlining one or more CPUs.

4. The method of claim 2, wherein restricting each respective container of the plurality of containers to the second amount of resources comprises using a process scheduler.

5. The method of claim 1, wherein the resources comprise memory resources.

6. The method of claim 1, wherein restricting each respective container of the plurality of containers to the second amount of resources comprises determining a difference between the first amount of resources and the second amount of resources.

7. The method of claim 1, wherein the operations further comprise, after executing the plurality of containers on the machine:
receiving a second request adjusting a quantity of containers in the plurality of containers;
determining a third amount of resources based on a sum of each resource requirement of each respective container of the adjusted plurality of containers; and
restricting each respective container of the adjusted plurality of containers to the third amount of resources.

8. The method of claim 7, wherein the second request terminates one or more containers of the plurality of containers.

9. The method of claim 7, wherein the second request adds one or more containers to the plurality of containers.

10. The method of claim 1, wherein executing the plurality of containers on the machine comprises enabling each respective container of the plurality of containers to consume a third amount of resources that is greater than the resource requirement of the respective container and less than the second amount of resources.

11. A system comprising:
data processing hardware; and
memory hardware in communication with the data processing hardware, the memory hardware storing instructions that when executed on the data processing hardware cause the data processing hardware to perform operations comprising:
receiving a request to provision a plurality of containers, each respective container of the plurality of containers to execute a respective software application, the request comprising, for each respective container of the plurality of containers, a resource requirement representing an amount of resources the respective container requires;
provisioning a machine for the plurality of containers, the machine comprising a first amount of resources;
determining a second amount of resources based on a sum of each resource requirement of each respective container of the plurality of containers, the second amount of resources less than the first amount of resources and greater than the resource requirement of each respective container of the plurality of containers;
restricting each respective container of the plurality of containers to the second amount of resources, the restriction prohibiting each respective container of the plurality of containers from utilizing more resources than the second amount of resources; and
after restricting each respective container of the plurality of contains to the second amount of resources, executing the plurality of containers on the machine.

12. The system of claim 11, wherein the resources comprise central processing unit (CPU) resources.

13. The system of claim 12, wherein restricting each respective container of the plurality of containers to the second amount of resources comprises offlining one or more CPUs.

14. The system of claim 12, wherein restricting each respective container of the plurality of containers to the second amount of resources comprises using a process scheduler.

15. The system of claim 11, wherein the resources comprise memory resources.

16. The system of claim 11, wherein restricting each respective container of the plurality of containers to the second amount of resources comprises determining a difference between the first amount of resources and the second amount of resources.

17. The system of claim 11, wherein the operations further comprise, after executing the plurality of containers on the machine:
receiving a second request adjusting a quantity of containers in the plurality of containers;
determining a third amount of resources based on a sum of each resource requirement of each respective container of the adjusted plurality of containers; and
restricting each respective container of the adjusted plurality of containers to the third amount of resources.

18. The system of claim 17, wherein the second request terminates one or more containers of the plurality of containers.

19. The system of claim 17, wherein the second request adds one or more containers to the plurality of containers.

20. The system of claim 11, wherein executing the plurality of containers on the machine comprises enabling each respective container of the plurality of containers to consume a third amount of resources that is greater than the resource requirement of the respective container and less than the second amount of resources.
